(19) United States
(12) Patent Application Publication
(10) Pub. No.: US 2015/0346827 A1
(43) Pub. Date: Dec. 3, 2015

(54) Mobile Control Unit and Method for Providing a Gesture Control of a Mobile Control Unit

(71) Applicant: Hella KGaA Hueck & Co., Lippstadt (DE)

(72) Inventors: Daniel Siekmann, Lippstadt (DE); Stefan Werner, Bocholt (DE)

(21) Appl. No.: 14/667,836

(22) Filed: Mar. 25, 2015

(30) Foreign Application Priority Data
Apr. 1, 2014 (DE) 102014104583.1

(51) Int. Cl. G06F 3/01; G06F 3/16; G06T 1/20

(52) U.S. Cl. CPC G06F 3/017; G06T 1/20; G06F 3/16

(57) ABSTRACT

A mobile control unit having an activation element, in which the mobile control unit is designed for performing a gesture control and the gesture control can be activated and/or deactivated by means of the activation element. The mobile control unit has a display device, wherein the display device is designed for indicating an activation state of the gesture control. Furthermore, a method for providing a gesture control of a mobile control unit, wherein the mobile control unit comprises at least an activation element and a display device.

### CROSS REFERENCE

This application claims priority to German Application No. 10 2014 104583.1, filed Apr. 1, 2014, which is hereby incorporated by reference.

### FIELD OF TECHNOLOGY

The present invention relates to a mobile control unit having an activation element, wherein the mobile control unit is designed for performing a gesture control and wherein the gesture control can be activated and/or deactivated by means of the activation element. Furthermore, the invention relates to a method for providing a gesture control of a mobile control unit, wherein the mobile control unit comprises at least an activation element and a display device.

### BACKGROUND

Mobile control units, which provide gesture control, are very popular in modern technology. For example, identification devices for vehicles, especially motor vehicles, can also be formed by such control units. At the same time, a gesture control is based on a measurement of a motion, which a user performs with a mobile control unit. For this purpose, a motion sensor is provided in the interior of the mobile control unit, which motion sensor is especially able to measure the position of the mobile control unit in the space, preferably in all three spatial dimensions, and/or an acceleration of the mobile control unit, also preferably in all three spatial dimensions. When evaluating these measurements, it is possible to recognize the gestures performed by the user and to translate the gestures in a gesture control into functions of an object to be controlled. For example, when an identification device of a motor vehicle is formed by such a mobile control unit, it is possible to represent many different functions of the vehicle. At the same time, it is possible to control the locking mechanism of the vehicle, to open and/or close the car trunk and doors of the vehicle, even to perform a remote-controlled movement of the vehicle.

By providing a gesture control, it is possible to achieve that the mobile control unit does not require any or only a few input elements, such as push buttons or knobs. In particular, this has the advantage that it is easier to protect such mobile control units against environmental influences. Moreover, equipping such a mobile control unit with a gesture control allows for a great deal of design freedom.

It is also possible to design the gesture control of the mobile control unit in such a way that it can be activated or deactivated. For this purpose, the mobile control unit can be provided with an activation element, which can be designed, for example, in the form of a switch and/or touch-sensitive surface. At the same time, the touch sensitivity can be provided especially by means of a capacitive sensor element. By activating or deactivating the gesture control, it is especially possible to use the control unit in an energy-saving manner, because the motion sensor is activated and thus consuming energy only when the gesture control is activated. At the same time, it is certainly also possible that the mobile control unit has an input element, for example, in the form of a touch-sensitive surface, which can be activated by the gesture control.

It proved to be difficult that the user is not able to recognize whether the gesture control of the mobile control unit is activated or deactivated. For example, when the gesture control is activated, a repeated activation attempt by the user can deactivate the activated gesture control. As a result, the usability of a mobile control unit according to prior art can be limited. Such unsuccessful activation attempts can also result in high energy consumption. In addition, unnecessarily long activation periods of the gesture control, which cannot be recognized and thus be stopped, can also result in high energy consumption.

### SUMMARY OF THE INVENTION

Therefore, it is the object of the present invention to eliminate at least to a certain extent the above-mentioned problems. In particular, it is the object of the present invention to produce in a cost-effective and simple manner a mobile control unit and a method for providing a gesture control in a mobile control unit, which is simplified and easier to actuate by the user, wherein especially unnecessary operations of the activation element and/or unnecessarily long activation periods of the gesture control can be prevented.

According to a first aspect of the invention, the problem is solved by a mobile control unit having an activation element, wherein the mobile control unit is designed to perform a gesture control and wherein the gesture control can be activated and/or deactivated by means of the activation element. An invention-based mobile control unit is characterized in that the mobile control unit has a display device, wherein the display device is designed to indicate an activation state of the gesture control. An invention-based mobile control unit is designed to perform a gesture control and has an activation element by means of which the gesture control can be activated and/or deactivated. At the same time, the mobile control unit has all elements required for performing the gesture control. For example, such elements can involve a position sensor or an acceleration sensor and the appropriate evaluation electronics, as well as communication elements, such as radio elements for transmitting the commands entered by the gesture control to the device to be controlled. By means of the gesture control, it is possible to control a device controlled by means of a mobile control unit merely by moving the mobile control unit, without requiring any further input elements. The gesture control of the mobile control unit can be activated and/or deactivated by means of the activation element. This has the advantage that during a period in which the user has deactivated the gesture control by actuating the activation element energy-consuming components, such as the sensors for the gesture control, can be switched to currentless mode. This allows for especially low-energy operation and thus for especially long service life of the mobile control unit, without requiring the energy storage system of the mobile control unit to be recharged.

An invention-based mobile control unit differs from generally known mobile control units in that the invention-based mobile control unit has a display device. By means of this display device, it is possible to indicate an activation state. Preferably, the display device can be switched to an active mode when the gesture control is activated and to an inactive mode, in which the display device is switched off, when the gesture control is deactivated. As a result, the user of the mobile control unit is always informed about the state of the mobile control unit and especially about the activation state of the gesture control of the mobile control unit. This can considerably increase the comfort of using such an invention-based control unit. Unnecessary input at the activation element can thus be avoided. Because of the fact that such unnecessary input also involves energy consumption, the invention also makes it possible that the invention-based control unit can be operated in an energy-saving manner. In addition, the user can recognize when the gesture control is activated and can terminate the activation state when no gesture control is required. Also in this way, it is possible to save energy when operating an invention-based mobile control unit.

According to a preferred further development of an invention-based control unit, it can also be provided that the display device has a display element for optically indicating an activation state of the gesture control. For a user it is especially easy to recognize such a visual display of the activation state provided by the display element of the display device. With merely one look on the mobile control unit, the user can determine immediately whether the gesture control is activated or deactivated. At the same time, such a display element can involve a light-emitting element, for example, a light-emitting diode. Light-emitting diodes have the special advantage that they are extremely durable and have low energy consumption. The display element or the display device can be shaped in different ways and do not limit the design of the mobile control unit. For example, it is also possible to use as a display element an illuminated pictogram which symbolizes the gesture control. It is also possible to use an illuminated company logo as display element of a display device.

In an especially preferred embodiment of an invention-based mobile control unit provision can also be made that the activation element has at least partially a transparent design and that the display element involves a background light of the activation element. When using the mobile control unit, the activation element is mostly manually operated by the user. As a result, the activation element is already in the focal range of the user and thus clearly visible. Such a background light of the activation element makes is easy to provide the user with feedback about the activation state of the gesture control. Furthermore, by providing a background light of the activation element as display element, it is possible to further reduce the required openings in a housing of the mobile control unit. Such openings in the housing of the mobile control unit often have to be sealed against environmental influences, for example, moisture. By reducing the number of these openings, it is possible to considerably simplify the structure and especially the sealing of the housing of the mobile control unit.

Furthermore, a mobile control unit can be designed in such a way that the display device has a display element for audibly indicating an activation state of the gesture control. For example, such a display element for providing an audible indication can involve a loudspeaker or any other appropriate signal device for acoustic signals. In particular, such a display element for audibly indicating an activation state of the gesture control has the advantage that acoustic signals can be perceived by the user even when the mobile control unit is not in the field of view of the user. Therefore, it is not required to explicitly observe the mobile control unit. For a user of a mobile control unit, acoustic signals and thus also a display element for audibly indicating an activation state of the gesture control represent an especially simple way of indicating an activation state of the gesture control.

Moreover, for a mobile control unit it can be also provided that the display device has a display element for haptically indicating an activation state of the gesture control. For example, such haptic indication can involve vibration or a vibration signal caused by vibration. In particular, such a display element for haptically indicating an activation state is designed to produce such a vibration signal. In order to actuate the activation element for activating the gesture control of the mobile control unit, the user of a mobile control unit has the mobile control unit already in hand. Therefore, the haptic indication of an activation state, produced especially by means of vibration and/or a vibration signal, makes it possible to provide the user immediately and directly with a tactile feedback about the activation or deactivation of the gesture control. In addition, a haptic display has the advantage that it can be excellently perceived by the user of the mobile control unit, but for any external party it is difficult to perceive. This can be of advantage in situations in which the gesture control should be activated without the knowledge of any third party.

For a mobile control unit, it can also be provided that during an activation state of the gesture control the display device indicates the activation state of the gesture control on a continuous basis. In particular, it can be provided that the display device indicates on a continuous basis the activation state when the gesture control is activated. As a result, it is possible to provide the user at any time with a feedback that the gesture control of the mobile control unit is activated. This can make it easier for the user to operate the mobile control unit.

According to an alternative or additional embodiment of a mobile control unit, it can be provided that during an activation state of the gesture control the display device indicates the activation state of the gesture control in intervals and/or for a limited period. For example, when deactivating the gesture control, it can be provided that the display device transmits a short, time-limited signal to indicate the deactivation of the gesture control. In intervals in terms of the invention can mean that, for example, a flashing light, several short acoustic signals or vibration signals, are transmitted. At the same time, such signals in intervals can be transmitted in regular intervals and/or repeated. By time-limiting a display of the activation state of the gesture control by means of the display device, it is also possible to operate a mobile control unit in an energy-saving manner. By stopping the display, the energy consumption of the display device is reduced, which allows for such energy-saving operation.

In an especially preferred manner, a mobile control unit can be designed in such a way that the mobile control unit involves an identification device for a vehicle. As a result, it is possible to control multiple functions of vehicles by means of such an invention-based mobile control device. For example, it is possible to control by means of such a mobile control unit a locking system of the vehicle, to open and/or close the doors of the vehicle or the car trunk. It is also possible to perform a remote-controlled movement of the vehicle. In addition, in the form of an identification device the mobile control unit can have further functions, for example, the identification of the user, as well as a release function for features to be performed by a plurality of users.

In a second aspect of the invention, the problem is solved by a method for providing a gesture control of a mobile control unit, in which the mobile control unit has at least an activation element and a display device. The invention-based method is characterized by the following steps:
a) detecting an actuation of the activation element,
b) activating the gesture control, and
c) indicating the active activation state of the gesture control by means of a display device.

After detecting an actuation of the activation element in step a) of the invention-based method, it is certainly possible to perform steps b) and c), i.e., activating the gesture control and indicating the active activation state of the gesture control by means of the display device, simultaneously or in any sequence. In modern technology such mobile control units, which provide gesture control, are used frequently. However, the fact that a constantly energized motion sensor, which is required for the gesture control, results in high energy consumption proved to be causing a problem. By actuating the gesture control by means of the activation element, it is possible to energize the sensor only when required, thus considerably reducing the energy consumption of such a mobile control unit. A further problem when using a mobile control unit and especially when providing the gesture control of the mobile control unit involves that the user of the mobile control unit is often not informed about the condition of the mobile control unit, especially about the activation state of the gesture control of the mobile control unit. This can result in unnecessary activation attempts of the gesture control. On the one hand, this can result in the fact that the mobile control unit is exposed to unnecessary stress and, on the other hand, the comfort of using the control unit is considerably reduced. It can also result in unnecessarily high energy consumption. Increased energy consumption can also result from the fact that an active, energy-consuming activation state of the gesture control is unnecessarily maintained for extended periods of time, because the user is not informed about the state and is not terminating it.

Step a) of the invention-based method provides the starting point of the invention-based method. By actuating the activation element, the user communicates that he is subsequently using the gesture control. In step b) of the invention-based method, the gesture control is activated. Naturally, this involves that all elements required for gesture control, for example, the motion and/or acceleration sensors and the appropriate evaluation electronics, as well as the communication elements, such as radio elements for transmitting the commands entered by the gesture control, are activated for the device to be controlled. Finally, in step c) of the invention-based method, the active activation state of the gesture control is indicated by the display device. As a result, the user of the mobile control unit receives a feedback about the state of the mobile control unit and especially about the activation state of the gesture control. Thus, at any point in time, he is informed as to whether he can use the gesture control or whether he first has to activate the gesture control. As a result, it is possible to avoid unnecessary repeated activation attempts of the gesture control, which would expose the mobile control unit to unnecessary stress and reduce the comfort of using the control unit. In addition, by means of the display of the activation state, the user is informed at any point in time when the gesture control is activated and can terminate it when it is no longer required. As a result, it is possible to avoid unnecessary energy consumption.

As an especially preferred feature of the invention-based method, it can be provided that the method is performed by means of a mobile control unit according to the first aspect of the invention. All advantages, which have been described with regard to a mobile control unit according to the first aspect of the invention, naturally apply also to an invention-based method which is performed by means of such an invention-based mobile control unit according to the first aspect of the invention.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a block diagram of an invention-based mobile control unit.

FIG. 2a is a block diagram illustrating a mobile control unit with a gesture control unit thereof not activated.

FIG. 2b is a block diagram of a display possibility of an active activation state of a gesture control unit.

FIG. 2c is a block diagram of an alternative display possibility of an active activation state of a gesture control unit.

### DETAILED DESCRIPTION OF THE DRAWINGS

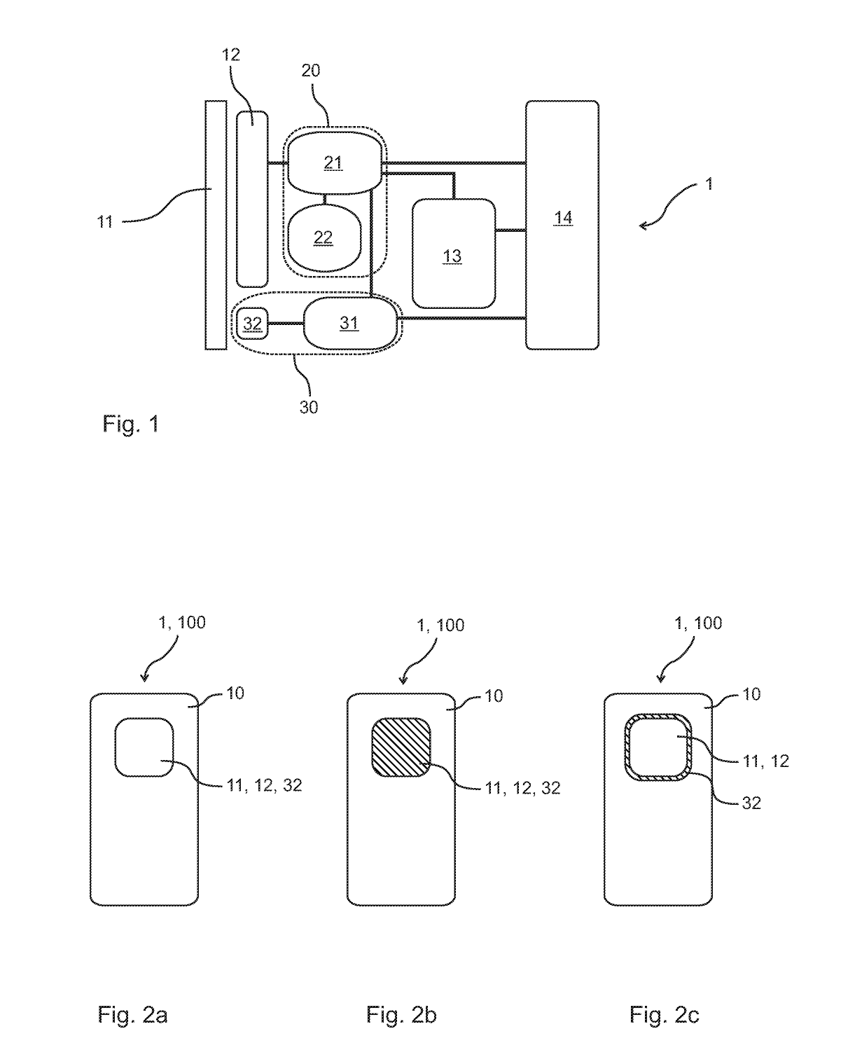

FIG. 1 shows a mobile control unit 1 in the form of a block diagram. Inside a housing 10 (not shown), the elements of a gesture control 20 and a display device 30 are arranged as important components. At the same time, the gesture control 20 and the display device 30 are supplied with energy by means of a power supply. The housing 10 is provided with a cover 11 behind which an activation element 12 is located. For example, the activation element 12 can be designed in the form of a touch-sensitive switch, for example, a capacitive sensor. When the user of the mobile control unit 1 places a finger on the cover 11, this is detected by the activation element 12 and transmitted to the electronics 21 of the gesture control 20. As a result, the electronics 21 of the gesture control 20 activates the motion sensor 22, as well as the electronics 31 of the display device 30. A display element 32 is controlled by the electronics 31 of the display device 30. As a result, when activating the gesture control 20, it is possible to indicate the now active activation state of the gesture control 20 by means of the display element 32 of the display device 30 and to provide the user of the mobile control unit 1 with a feedback. In this case, the display element 32 shown involves an illuminant, for example, an LED. For this purpose, the cover 11 has at least partially a transparent design, whereby the user of the mobile control unit 1 receives a visual feedback about the activation state of the gesture control 20. It is certainly also possible to use different display elements 32, for example, acoustic display elements 30, such as loudspeakers, or haptic display elements 32, such as vibration signals. It is essential that by means of the display element 32 of the display device 30 the user of the mobile control unit 1 can receive a feedback to the effect that the gesture control 20 is activated or deactivated. When the gesture control 20 is activated, the user of the mobile control unit 1 can perform a movement, which is measured by means of the motion sensor 22. This measurement is evaluated in the electronics 21 of the gesture control 20 and transmitted to the device to be controlled by means of a radio element 13. For example, such a device can involve a vehicle, the locking system of which can be operated in a controlled manner by means of the mobile control unit 1.

FIGS. 2a, 2b, and 2c show different embodiments of identification devices 100 for vehicles, which are formed by a mobile control unit 1 according to the invention. Each of the identification devices 100 has a housing 10, in which a cover 11 has been inserted behind which the activation element 12 is located. At the same time, each cover 11 of the identification device 100 has at least partially a transparent design, by means of which a visual display element 32, which is located behind the cover 11, is arranged for optically showing an activation state of a gesture control 20 (not shown) of the mobile control unit 1 designed in the form of an identification device 100. In FIG. 2a, the gesture control 20 of the mobile control unit 1 is not activated. This deactivated state of the gesture control 20 is also indicated by absence of an active display. FIGS. 2b and 2c show, respectively, different display possibilities of an active activation state of the gesture control 20. For example, in FIG. 2b, the entire cover 11 has a transparent design so that by means of the display element 32 a background light can be produced for the entire cover 11. This background light produced by the display element 32 indicates that the gesture control 20 is activated. In FIG. 2c, only the outside edge of the cover 11 has a transparent design. When the display element 32 indicates an active gesture control 20, only the edge of the cover 11 is visually illuminated. It is certainly also possible to provide the display elements 32 with different embodiments for a visual display. In addition, the display element 32 can be designed also for audibly and/or haptically indicating the activation state of the gesture control 20 (not shown). It is certainly also possible that the display element indicates the activation state of the gesture control 20 on a continuous basis or in intervals and/or for a limited period.

### REFERENCE LIST

1 Mobile control unit
10 Housing
11 Cover
12 Activation element
13 Radio element
14 Power supply
20 Gesture control
21 Electronics of the gesture control
22 Motion sensor
30 Display device
31 Electronics of the display device
32 Display element
100 Identification device

1. A mobile control unit designed for performing a gesture control, said mobile control unit comprising:
an activation element, activating or deactivating the gesture control;
a display device indicating an activation state of the gesture control.

2. The mobile control unit according to claim 1, wherein the display device has a display element for optically indicating an activation state of the gesture control.

3. The mobile control unit according to claim 2, wherein the activation element has at least partially a transparent design and that the display element involves a background light of the activation element.

4. The mobile control unit according to claim 1 wherein the display device has a display element for audibly indicating an activation state of the gesture control.

5. The mobile control unit according to claim 1 wherein the display device has a display element for haptically indicating an activation state of the gesture control.

6. The mobile control unit according to claim 1 wherein during an activation state of the gesture control, the display device indicates on a continuous basis the activation state of the gesture control.

7. The mobile control unit according to claim 1 wherein during an activation state of the gesture control, the display device indicates in intervals and/or for a limited period the activation state of the gesture control.

8. The mobile control unit according to claim 1 wherein the mobile control unit involves an identification device for a vehicle.

9. A method for providing a gesture control of a mobile control unit, wherein the mobile control unit comprises at least an activation element and a display device, comprised by the following steps:
a) detecting an actuation of the activation element,
b) activating the gesture control, and
c) indicating the active activation state of the gesture control by means of a display device.

10. The method according to claim 9, wherein the method is performed by means of a mobile control unit according to claim 1.
